(19) United States
(12) Patent Application Publication
(10) Pub. No.: US 2009/0208235 A1
(43) Pub. Date: Aug. 20, 2009

(54) TERMINAL DEVICE, IMAGE FORMING APPARATUS, AND PRINTING SYSTEM HAVING THE SAME, AND PRINTING METHOD THEREOF

(75) Inventor: Tae-sun YOON, Anyang-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/327,103

(22) Filed: Dec. 3, 2008

(30) Foreign Application Priority Data
Feb. 19, 2008 (KR) 2008-14916

(51) Int. Cl. G03G 15/20

(52) U.S. Cl. 399/67; 399/69; 399/70

(57) ABSTRACT

A printing method using a terminal device connected to an image forming apparatus includes analyzing an object of an initial page of a medium to be printed and setting fusing conditions if a print command is input, and transmitting the set fusing conditions and print data to the image forming apparatus. The fusing conditions are set differently according to characteristics of an initial page of a medium to be printed, and thus the preheating time can be reduced and the printing speed can be increased.

### CROSS-REFERENCE TO RELATED APPLICATIONS

This application claims priority under 35 U.S.C. §119(a) from Korean Patent Application No. 2008-14916, filed on Feb. 19, 2008, in the Korean Intellectual Property Office, the contents of which are incorporated herein by reference in its entirety.

### BACKGROUND OF THE INVENTION

1. Field of the Invention

The present general inventive concept relates to a terminal device, an image forming apparatus and a printing system having the same, and a printing method thereof. More particularly, the present general inventive concept relates to a terminal device capable of reducing preheating time so as to increase printing speed under fusing conditions set according to characteristics of an initial page of a medium to be printed, to an image forming apparatus and to a printing system having the same, and to a printing method thereof.

2. Description of the Related Art

An image forming apparatus generally prints print data provided from a terminal device, such as a computer, onto a recording medium. Examples of such image forming apparatuses include copiers, printers, facsimile machines or multifunction peripherals (MFPs), which combine functions of copiers, printers and facsimile machines into a single system.

Such image forming apparatuses are classified into various types, for example, dot, inkjet or laser image forming apparatus. Among these, laser image forming apparatuses perform printing more rapidly and output images of higher quality than other image forming apparatuses. Accordingly, laser image forming apparatuses have become increasingly widely used.

Such laser image forming apparatuses perform a fusing operation to cause toner on a surface of a photosensitive medium to adhere to a printing medium. The fusing operation is performed to fuse toner onto the printing medium using a predetermined temperature and pressure. Here, since the predetermined temperature is used to perform the fusing operation, preheating time is required to heat a fusing device.

Therefore, in order to perform the fusing operation, laser image forming apparatuses require not only time to perform printing but also preheating time to raise the temperature of the fusing device. The preheating time significantly affects the first page out time (FPOT), which is one of performance characteristics of image forming apparatuses.

### SUMMARY OF THE INVENTION

The present general inventive concept provides a terminal device capable of reducing or controlling a preheating time so as to increase printing speed under fusing conditions set according to characteristics of an initial page of a medium to be printed, an image forming apparatus and a printing system having the same, and a printing method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a printing method using a terminal device connected to an image forming apparatus, the printing method including analyzing an object of an initial page of a medium to be printed, and setting fusing conditions, if a print command is input; and transmitting the set fusing conditions and print data to the image forming apparatus.

The setting of the fusing conditions may include setting the fusing conditions to correspond to the object characteristics of the initial page among a plurality of fusing condition settings predefined according to the object characteristics of the initial page of the medium to be printed.

The printing method may further include displaying the set fusing conditions.

The set fusing conditions may be changeable.

The fusing conditions may include either a fusing temperature or a preheating time.

The printing method may further include determining whether or not it is necessary to set the fusing conditions according to information regarding the status of the image forming apparatus.

The set fusing conditions may be added in a printer job language (PJL), and the PJL including the fusing conditions may be transmitted.

The fusing conditions set by analyzing the object of the initial page may be different from those of the other pages.

The foregoing and/or other aspects and utilities of the present general inventive concept may also be achieved by providing a printing method, including determining fusing conditions of an initial page of a medium to be printed; and printing print data according to the determined fusing conditions.

The determining of the fusing conditions may be performed by receiving the recognized fusing condition, or analyzing the initial page of the print data.

The determining may include displaying the fusing conditions; and receiving user confirmation of the displayed fusing condition.

The fusing conditions may be set to correspond to the object characteristics of the initial page among a plurality of fusing condition settings predefined according to the object characteristics of the initial page of the medium to be printed.

The printing method may further include determining whether or not it is necessary to set the fusing conditions according to information regarding the status of the image forming apparatus.

The fusing conditions set by analyzing the object of the initial page may be different from those of the other pages.

The foregoing and/or other aspects and utilities of the present general inventive concept may also be achieved by providing a terminal device, including a control unit to analyze an object of an initial page of a medium to be printed, and to set fusing conditions, if a print command is input; and an interface to transmit the set fusing conditions and print data to an image forming apparatus.

The control unit may set the fusing conditions to correspond to an object characteristics of the initial page among a plurality of fusing condition settings predefined according to the object characteristics of the initial page of the medium to be printed.

The control unit may determine whether it is necessary to set the fusing conditions according to information regarding the status of the image forming apparatus, and set the fusing conditions if it is necessary.

The terminal device may further include a user interface to display the fusing conditions, and to receive a control command from a user.

The foregoing and/or other aspects and utilities of the present general inventive concept may also be achieved by providing an image forming apparatus, including a fusing unit to carry out fusing; and a control unit to determine fusing conditions of an initial page of a medium to be printed, and to cause print data to be printed according to the determined fusing condition.

The control unit may set the fusing conditions by receiving the fusing conditions of the initial page of the medium to be printed from a terminal device and determining the received fusing conditions, or analyzing the initial page of the print data received from the terminal device.

The control unit may set the fusing conditions to correspond to the object characteristics of the initial page among a plurality of fusing condition settings predefined according to the object characteristics of a page to be printed.

The control unit may determine whether it is necessary to set the fusing conditions according to information regarding the status of the image forming apparatus, and sets the fusing condition if it is necessary.

The control unit may control the fusing unit to carry out fusing in conditions different from those of the initial page, after printing of the print data has started.

The foregoing and/or other aspects and utilities of the present general inventive concept may also be achieved by providing a printing system, including a terminal device to analyze an object of an initial page of a medium to be printed, to set fusing conditions, and to transmit the set fusing conditions and print data to an image forming apparatus if a print command is input; and an image forming apparatus to set the fusing conditions by receiving the fusing conditions of the initial page of the medium to be printed from the terminal device and recognizing the received fusing conditions, and to print print data if the fusing conditions are appropriate.

The foregoing and/or other aspects and utilities of the present general inventive concept may also be achieved by providing a method of a printing system, the method including analyzing an object of an initial page of a medium to be printed, setting fusing conditions, and transmitting the set fusing conditions and print data to an image forming apparatus if a print command is input, controlling a fusing unit according the fusing conditions of the initial page of the medium to be printed, and printing print data if the fusing conditions are appropriate.

The foregoing and/or other aspects and utilities of the present general inventive concept may also be achieved by providing an image forming apparatus of a printing system, including a fusing unit, and a control unit to control a preheating time and a fusing temperature of the fusing unit according to a portion of a text included in an initial page of one or more pages to be printed.

The foregoing and/or other aspects and utilities of the present general inventive concept may also be achieved by providing a printing system, including a terminal device to generate print data including one or more pages and to generate one or more printing conditions according to a text portion of an initial page of the one or more pages of the print data so as to control a fusing temperature and a preheating time of a fusing unit.

The foregoing and/or other aspects and utilities of the present general inventive concept may also be achieved by providing a printing system including a terminal device to generate print data including one or more pages and to generate one or more printing conditions according to a text portion of an initial page of the one or more pages of the print data, and an image forming apparatus including a developing unit, a fusing unit, and a control unit to control the developing unit to print the print data and to control a preheating time and a fusing temperature of the fusing unit according to the printing conditions.

The foregoing and/or other aspects and utilities of the present general inventive concept may also be achieved by providing a computer-readable medium to contain computer-readable codes as a program to perform a method of a printing system, the method including generating print data including one or more pages, and generating one or more printing conditions according to a text portion of an initial page of the one or more pages of the print data, controlling a developing unit to print the print data, and controlling a preheating time and a fusing temperature of a fusing unit according to the printing conditions.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating a printing system according to an exemplary embodiment of the present general inventive concept;

FIG. 2 is a block diagram illustrating a terminal device according to an exemplary embodiment of the present general inventive concept;

FIG. 3 is a block diagram illustrating an image forming apparatus according to an exemplary embodiment of the present general inventive concept;

FIG. 4 is a flowchart illustrating a printing method using a terminal device according to an exemplary embodiment of the present general inventive concept;

FIG. 5 is a flowchart illustrating a printing method in an image forming apparatus according to an exemplary embodiment of the present general inventive concept; and

FIG. 6 illustrates a look-up table usable in a terminal device or an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

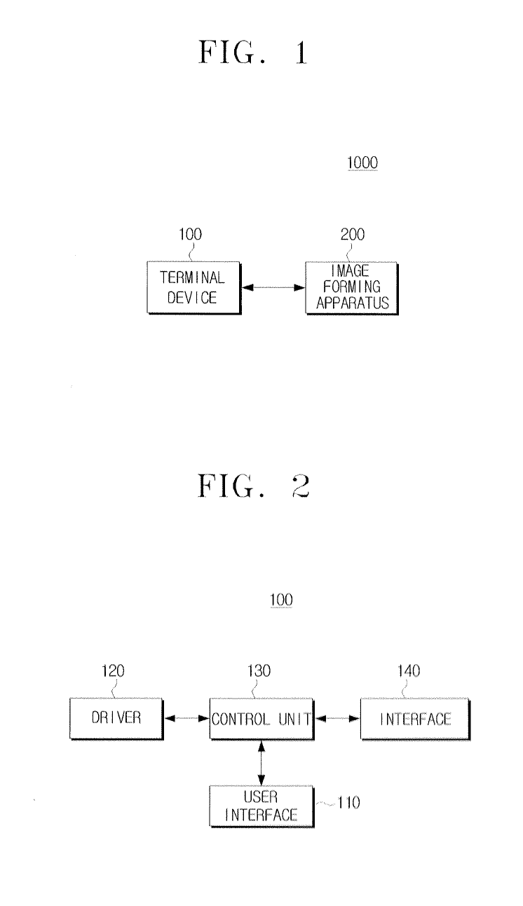

FIG. 1 is a block diagram illustrating a printing system 1000 according to an exemplary embodiment of the present general inventive concept.

The printing system 1000 of FIG. 1 includes a terminal device 100 and an image forming apparatus 200.

The terminal device 100 and the image forming apparatus 200 can be made in a signal integrated body, or can be formed in separate bodies to communicate with each other using a wired or wireless communication line or network.

If a print command is input, the terminal device 100 analyzes an initial page of a medium to be printed, sets fusing conditions and transmits the set fusing conditions and print data to the image forming apparatus 200. Hereinafter, the configuration and functions of the terminal device 100 will be described in detail with reference to FIG. 2.

FIG. 2 is a block diagram illustrating the terminal device 100 according to an exemplary embodiment of the present general inventive concept. The terminal device 100 of FIG. 2 includes a user interface 110, a driver 120, a control unit 130 and an interface 140.

If a user desires to print a document written by an application program, the driver 120 converts the document into print data in printable format. In this situation, the user may set one or more printing conditions using one or more functions provided by the driver 120 or by the application program. The printing conditions may include information regarding whether a fusing temperature control function is applied to control or adjust (increase or decrease) a temperature of a fusing unit to fix or fuse a toner image on the printing medium. The above converting function of the driver 120 may be executed by the control unit 130.

The control unit 130 may determine whether it is necessary to set one or more fusing conditions as the printing conditions according to information regarding the status of the image forming apparatus 200. In more detail, the control unit 130 may determine the status of the image forming apparatus 200, for example, whether the image forming apparatus 200 is in a warming-up, stand-by or printing status, and may then determine whether a preheating operation is required. For example, if the image forming apparatus 200 is currently performing printing or if the preheating operation has finished, there is no need to perform the preheating operation, so an operation for setting the fusing conditions is omitted. The control unit 130 may determine whether it is necessary to set the fusing conditions, using the information regarding the status of the image forming apparatus 200, as described above, or using information regarding a current fusing temperature of a fusing unit of the image forming apparatus 200. The control unit 130 may receive the information regarding the status or the information regarding the fusing temperature from the image forming apparatus 200.

The control unit 130 may analyze an initial page of a medium to be printed according to the document and/or the print data, and set fusing conditions. Specifically, the control unit 130 may set the fusing conditions to correspond to one of a plurality of fusing condition settings predefined according to object characteristics of the initial page of the medium to be printed or according to a proportion of text on the page.

The object characteristics of the initial page of the medium may be a ratio, such as a text and non-text ratio, a text and image ratio, a text and blank area ratio, etc.

The fusing conditions may be expressed numerically, such as the fusing temperature or preheating time. For example, the fusing conditions may be set according to a first situation, in which the initial page contains only text (that is, the proportion of text is within a range of 80 to 100%); a second situation, in which the initial page contains only graphics or bitmaps (that is, the proportion of text is within a range of 0 to 20%); or a third situation, in which the initial page contains some graphics or bitmaps (that is, the proportion of text is within a range of 20 to 80%). Therefore, the fusing conditions may vary according to the situation.

If the fusing temperature is one of the fusing conditions, printing begins in the second situation, which has the lowest proportion of text, when the fusing temperature reaches a fusing temperature α. The fusing temperature α may be referred to as a normal fusing temperature. In the third situation, printing begins when the fusing temperature reaches a fusing temperature β. In the first situation, which has the highest proportion of text, printing begins when the fusing temperature reaches a fusing temperature γ. The temperatures α, β and γ may satisfy the relationship α>β>γ.

If the preheating time of a fusing unit is one of the fusing conditions, a preheating time T1 is applied in the first situation, a preheating time T2 longer than T1 is applied in the third situation, and a preheating time T3 longer than T2 is applied in the second situation. The preheating time T1 may be referred to as the shortest preheating time for the fusing unit to generate heat to reach a predetermined fusing temperature, the preheating time T2 may be referred to as the longest preheating time, and the preheating time T3 may be referred to as a normal preheating time.

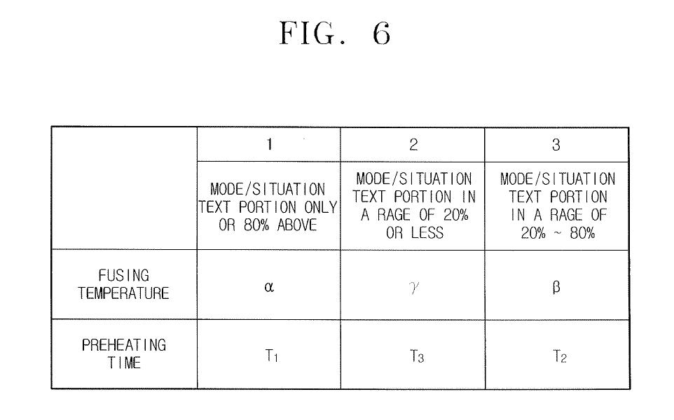

FIG. 6 illustrates a look-up table stored in a memory unit of a control unit 130 of the terminal device 100 or a memory unit of a control unit 230 of the image forming apparatus. It is possible that the printing system may have a memory unit to store the look-up table such that the control unit can make a determination of whether printing condition is required and/or can determine the printing condition according to data of the look-up table. The look-up table illustrates a portion of text with respect to an initial page of one or more pages which correspond to the print data to be printed on the one or more pages.

The situations may be divided into a normal fusing situation and an abnormal fusing situation instead of the three or more situations. That is, if the initial page is a text page, the fusing temperature is set to be a temperature below the normal fusing temperature, and if the initial page is a non-text page, the fusing temperature is set to be the normal fusing temperature.

Conventional image forming apparatuses perform fusing at a high fusing temperature applied to all objects regardless of characteristics of a current page to be printed. However, in a page having only text objects, since toner is comparatively thinly attached to a medium whereon printing is performed, a desired printing quality can be obtained at a temperature below a generally set normal fusing temperature. Therefore, if a current page includes only text objects or simple graphic objects such as lines, the fusing operation can be determined to be performed according to the preheating time and fusing temperature corresponding to characteristics of the objects.

The fusing temperature and preheating time corresponding to characteristics of the objects may be determined separately according to the characteristics of the image forming apparatus. The classification described above is merely an example. Accordingly, more detailed classification is also possible, so optimal fusing conditions for each case are measured experimentally and applied.

The control unit 130 may set the fusing conditions using printing setting information, such as the printing resolution and printing quality, as well as using characteristics of the objects on an initial page.

The user interface 110 may display the set fusing conditions. The user may alter the determined fusing conditions. More specifically, if the user wishes to obtain high quality output rather than rapid printing, he or she can alter the set fusing conditions in order to output higher quality. If the terminal device 100 is a computer, the user interface 110 may be implemented as a keyboard or mouse and a CRT or LCD monitor.

It is possible that the above-set fusing temperature and the preheating time can be controlled or adjusted with respect to the quality, resolution, and printing speed.

The interface 140 is connected to the image forming apparatus 200, and provides the image forming apparatus 200 with the determined fusing conditions and print data. In greater detail, the interface 140 connects the terminal device 100 to an external device, and may be implemented as a parallel port, a universal serial bus (USB) port or a wireless module. If the terminal device 100 is a computer, the interface 140 is connected to the image forming apparatus 200, such as a printer, and transmits a document produced using the computer to the image forming apparatus 200. The determined fusing conditions may be transmitted to the image forming apparatus 200 using a printer job language (PJL) command.

The image forming apparatus 200 confirms the fusing conditions of the initial page to be printed, and performs a printing operation if the fusing conditions are satisfied. The image forming apparatus 200 may confirm the fusing conditions by receiving information on the fusing conditions determined by the terminal device 100 or by analyzing characteristics of the objects on the initial page and determining the fusing conditions by itself.

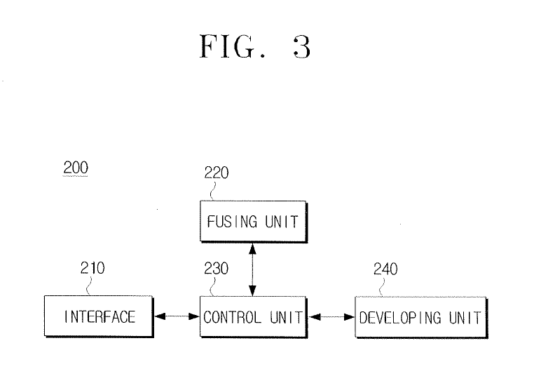

The image forming apparatus 200 may be connected to the terminal device 100 which performs a printing operation according to this exemplary embodiment of the present general inventive concept, or to a terminal device which performs a conventional printing operation. The image forming apparatus 200 may be connected to the terminal device 100 locally or through a network. In addition, the image forming apparatus 200 may be connected to the terminal device 100 via wire or wirelessly. Detailed description of the image forming apparatus 200 and functions thereof is provided here with reference to FIG. 3.

FIG. 3 is a block diagram illustrating an image forming apparatus 200 according to an exemplary embodiment of the present general inventive concept. The image forming apparatus 200 may include an interface 210, a fusing unit 220, a control unit 230, and a developing unit 240.

The interface 210 may be connected to a terminal device, and receives print data and fusing conditions from the terminal device. That is, the interface 210 connects the image forming apparatus 200 to an external device, for example, the terminal device 100 according to an exemplary embodiment of the present general inventive concept, and may be implemented as a parallel port, a universal serial bus (USB) port or a wireless module. If the terminal device 100 is a computer, the interface 210 receives a print document which has been produced using the computer and converted into a language capable of being recognized by the image forming apparatus 200.

The developing unit 240 performs a developing operation to develop and form a toner image according to the print data, and the fusing unit 220 performs a fusing operation to fuse the toner image on the medium.

The fusing unit 220 performs a fusing operation by providing heat and pressure to the medium, such as a sheet of paper. In more detail, in order to fuse toner onto paper, the fusing unit 220 may include a fusing roller and a pressure roller which are disposed facing each other so as to pass the paper therebetween. A heating unit may be formed in the fusing roller to provide heat to the paper according to the fusing conditions.

The control unit 230 may confirm the fusing conditions of the initial page and control the print data to be printed if the confirmed fusing conditions are satisfied. In greater detail, the control unit 230 parses the print data, confirms the fusing conditions, and controls the fusing temperature and preheating time of the fusing unit 220. The operation of confirming the fusing conditions is performed in a manner that if the image forming apparatus 200 is connected to the terminal device 100 according to the exemplary embodiment of the present general inventive concept, the fusing conditions are confirmed using the received fusing conditions, and if the image forming apparatus 200 is connected to a conventional terminal device which does not provide additional fusing conditions, the fusing conditions are confirmed by analyzing the initial page of the received print data. The operation of analyzing the initial page of the medium to be printed is similar to that of the control unit 120 of the terminal device.

The control unit 230 confirms the fusing conditions of the initial page to be printed, and if the preheating operation is required, controls the fusing unit 220 to operate according to the determined fusing conditions. For example, if the fusing temperature of the determined fusing conditions is determined to be lower than the normal fusing temperature, the control unit 230 causes the fusing unit 220 to be heated, and if the fusing temperature of the determined fusing conditions is determined to be higher than the normal fusing temperature, the control unit 230 causes the print data to be printed.

The control unit 230 may control the fusing unit 220 to execute a fusing operation at the normal fusing temperature, after printing of the print data has started. Specifically, the fusing conditions set by analyzing the object of the initial page may be different from those of the following (next) pages. Accordingly, the control unit 230 starts a printing operation of the initial page if the temperature of the fusing unit reaches a calculated fusing temperature, but the control unit 230 causes the fusing unit 220 to be heated after the printing has started in order to reach the normal fusing temperature of the next pages to be printed after a printing operation on the initial page is completed.

The image forming apparatus 200 is connected to the terminal device 100 over wire or wirelessly in FIGS. 1 to 3, but the image forming apparatus 200 of an exemplary embodiment of the present general inventive concept may operate without being connected to the terminal device 100. When the document stored in the image forming apparatus is used, or when the document stored in an external storage medium is printed, the image forming apparatus 200 may analyze an object of an initial page of the stored document, set fusing conditions, and print the print data according to the set fusing conditions.

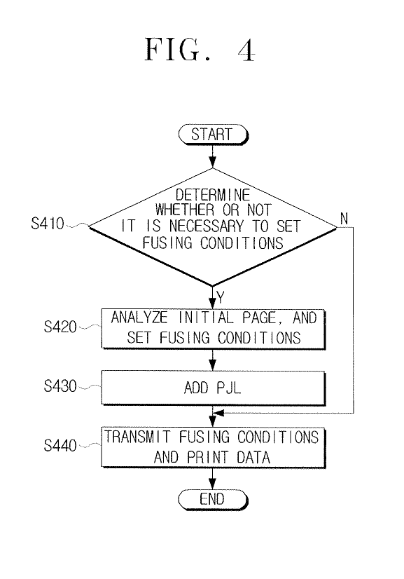

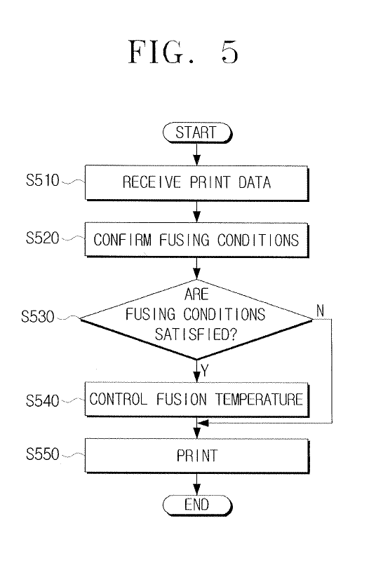

FIG. 4 is a flowchart illustrating a printing method using a terminal device according to an exemplary embodiment of the present general inventive concept.

Referring to FIG. 4, if a print command is input, the printing method using a terminal device according to an exemplary embodiment of the present general inventive concept determines whether or not it is necessary to set the fusing conditions according to information regarding the status of the image forming apparatus in operation S410. Specifically, if the image forming apparatus is performing printing, or has been preheated, it is unnecessary to preheat the image forming apparatus. Accordingly, print data may be transmitted without the process of setting the fusing conditions in operation S440. Whether or not it is necessary to determine the fusing conditions may be determined using the information regarding the status of the image forming apparatus.

If the preheating operation is necessary, the terminal device analyzes an object of an initial page of a medium to be printed, and sets the fusing conditions in operation S420. More specifically, the terminal device sets the fusing conditions to correspond to the object of the initial page of the medium to be printed from among a plurality of fusing conditions predefined according to the object characteristics of the initial page of the medium to be printed, for example the fusing temperature or preheating time. If the fusing conditions are set, the set fusing conditions are added to a printer job language (PJL) in operation S430, and the PJL and print data are transmitted to the image forming apparatus in operation S440. A process by which the set fusing conditions are confirmed by the user may be applied. Specifically, the set fusing conditions are displayed on a display, and the user may determine whether to perform the fusing operation using the set fusing conditions. If the user does not desire to print a medium using the set fusing conditions, normal fusing conditions may be transmitted to the image forming apparatus instead of the set fusing conditions.

FIG. 5 is a flowchart illustrating a printing method of an image forming apparatus according to an exemplary embodiment of the present general inventive concept.

Referring to FIG. 5, according to the printing method of the image forming apparatus in an exemplary embodiment of the present general inventive concept, print data is firstly received from the terminal device in operation S510, and then whether or not it is necessary to preheat the image forming apparatus is determined. If preheating the image forming apparatus is unnecessary, the image forming apparatus prints the received print data in operation S550, and if it is necessary, the image forming apparatus confirms the fusing conditions in operation S520, and causes the fusing unit to be preheated to carry out the fusing operation at normal fusing conditions in operations S530 and S540.

The image forming apparatus confirm fusing conditions of an initial page of a medium to be printed, and if the fusing conditions are satisfied, the image forming apparatus controls to print the print data. More specifically, if the fusing conditions are received, the image forming apparatus may determine whether or not the fusing conditions are satisfied using the received fusing conditions. However, if the fusing conditions are not received, the image forming apparatus may analyze an object of an initial page of a medium to be printed, set the fusing conditions, and determine whether or not the fusing conditions are satisfied using the set fusing conditions. The operation of analyzing the initial page of the medium to be printed is identical to the operation performed by the control unit 120 of the terminal device.

If the fusing conditions satisfy the set fusing conditions, printing of the received print data is started. The current fusing conditions are controlled so that the fusing operation may be carried out under normal fusing conditions after printing has started. That is, the fusing conditions of pages following an initial page may be different from that of the initial page, which are set by analyzing the object thereof.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

According to the present general inventive concept, the fusing conditions are set differently according to characteristics of an initial page of a medium to be printed, so the preheating time may be reduced and printing speed may be increased.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printing method using a terminal device connected to an image forming apparatus, the printing method comprising:
analyzing an object of an initial page of a medium to be printed, and setting one or more fusing conditions, if a print command is input; and
transmitting the set fusing conditions and print data to the image forming apparatus.

2. The printing method of claim 1, wherein the setting of the fusing conditions comprises:
setting the fusing conditions to correspond to the object characteristics of the initial page among a plurality of fusing condition settings predefined according to the object characteristics of the initial page of the medium to be printed.

3. The printing method of claim 1, further comprising:
displaying the set fusing conditions.

4. The printing method of claim 3, wherein the set fusing conditions are changeable.

5. The printing method of claim 1, wherein the fusing conditions comprise either a fusing temperature or a preheating time.

6. The printing method of claim 1, further comprising:
determining whether or not it is necessary to set the fusing conditions according to information regarding the status of the image forming apparatus.

7. The printing method of claim 1, wherein the set fusing conditions are added in a printer job language (PJL), and the PJL including the fusing conditions is transmitted.

8. The printing method of claim 1, wherein the fusing conditions set by analyzing the object of the initial page are different from those of the other pages.

9. A printing method, comprising:
determining one or more fusing conditions of an initial page of a medium to be printed; and
printing print data according to the determined fusing conditions,
wherein the determining of the fusing conditions is performed by receiving the recognized fusing condition, or analyzing the initial page of the print data.

10. The printing method of claim 9, wherein the determining comprises:
displaying the fusing conditions; and
receiving user confirmation of the displayed fusing condition.

11. The printing method of claim 9, wherein the fusing conditions are set to correspond to the object characteristics of the initial page among a plurality of fusing condition settings predefined according to the object characteristics of the initial page of the medium to be printed.

12. The printing method of claim 10, further comprising:
determining whether or not it is necessary to set the fusing conditions according to information regarding the status of the image forming apparatus.

13. The printing method of claim 9, wherein the fusing conditions set by analyzing the object of the initial page are different from those of the other pages.

14. A terminal device, comprising:
a control unit to analyze an object of an initial page of a medium to be printed, and to set fusing conditions, if a print command is input;
an interface to transmit the set fusing conditions and print data to an image forming apparatus; and
a user interface to display the fusing conditions, and to receive a control command from a user.

15. The terminal device of claim 14, wherein the control unit sets the fusing conditions to correspond to an object characteristics of the initial page among a plurality of fusing condition settings predefined according to the object characteristics of the initial page of the medium to be printed.

16. The terminal device of claim 14, wherein the control unit determines whether it is necessary to set the fusing conditions according to information regarding the status of the image forming apparatus, and sets the fusing conditions if it is necessary.

17. An image forming apparatus, comprising:
a fusing unit to carry out fusing; and
a control unit to determine fusing conditions of an initial page of a medium to be printed, and to cause print data to be printed according to the determined fusing condition.

18. The image forming apparatus of claim 17, wherein the control unit sets the fusing conditions by receiving the fusing conditions of the initial page of the medium to be printed from a terminal device and determining the received fusing conditions, or analyzing the initial page of the print data received from the terminal device.

19. The image forming apparatus of claim 17, wherein the control unit sets the fusing conditions to correspond to the object characteristics of the initial page among a plurality of fusing condition settings predefined according to the object characteristics of a page to be printed.

20. The image forming apparatus of claim 19, wherein the control unit determines whether it is necessary to set the fusing conditions according to information regarding the status of the image forming apparatus, and sets the fusing condition if it is necessary.

21. The image forming apparatus of claim 19, wherein the control unit controls the fusing unit to carry out fusing in conditions different from those of the initial page, after printing of the print data has started.

22. A printing system, comprising:
a terminal device to generate print data including one or more pages and to generate one or more printing conditions according to a text portion of an initial page of the one or more pages of the print data; and
an image forming apparatus including a developing unit, a fusing unit, and a control unit to control the developing unit to print the print data and to control a preheating time and a fusing temperature of the fusing unit according to the printing conditions.
